(19) United States
(12) Patent Application Publication
(10) Pub. No.: US 2006/0290801 A1
(43) Pub. Date: Dec. 28, 2006

(54) Digital camera module with improved image quality

(75) Inventor: Ching-Lung Jao, Miao-Li (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ALTUS TECHNOLOGY INC., Miao-li (TW)

(21) Appl. No.: 11/441,485

(22) Filed: May 26, 2006

(30) Foreign Application Priority Data
Jun. 24, 2005 (CN) 200510035555.0

(51) Int. Cl. G02B 13/16

(52) U.S. Cl. 348/335

(57) ABSTRACT

A digital camera module (100) includes a lens holder (20), a lens mount (22), and an image pick-up module (24). The lens holder defining a central hollow, and has at least one lens (206[check number]) received therein. The lens mount defining a central hollow, and an inner diameter of the lens holder being slightly greater than or equal to an outer diameter of the lens mount such that the lens holder capable of locating around the lens mount and movable along an axis of the lens mount. The image pick-up module is arranged so as to receive the light from the lenses.

### BACKGROUND OF THE INVENTION

1. Field of the Invention

The present invention relates generally to digital camera modules and, more particularly, to a digital camera module which improves image quality.

2. Discussion of the Related Art

Generally, digital cameras are image recording media capable of photographing a plurality of still images without using regular film. Such a digital camera typically uses an image pickup device, which is a kind of semiconductor device, such as a charge coupled device (CCD) or complementary metal oxide semiconductor (CMOS). In the digital camera, an object image formed on the image pickup device through a lens is converted into an electrical signal by the image pickup device, and the electrical signal is stored as a digital signal in a mobile phone or PDA in which the digital camera is mounted.

A digital camera module, as shown in FIG. 3, includes a lens barrel 10, a lens holder 12, and an image pick-up module 14. The lens barrel 10 has an external thread 102, and the lens holder 12 has an internal thread 122. The lens barrel 10 is received in the lens holder 12 via the thread engagement between the external thread 102 and the internal thread 122. The image pick-up module 14 includes a base plate 142 and an image pick-up chip 144. The lens holder 12 is fixed on the base plate 142. DuringDuring auto-focusing, a distance between the lens barrel 10 and the image pick-up chip 144 is slightly adjusted to make the digital camera module focus by means of adjusting the thread engagement of the internal thread 122 of the lens holder 12 and the external thread 102 of the lens barrel 10. Lastly, the lens holder 12 is secured on the base plate 142 via adhesive.

However, dust and/or particle pollution/contamination associated with friction between the lens barrel 10 and the lens holder 12 may fall onto the image pick-up chip 144, thus affecting image quality of the digital camera module.

What is needed, therefore, is a digital camera module, which overcomes the above-described problem.

### SUMMARY OF THE INVENTION

A digital camera module comprises a lens holder, a lens mount, and an image pick-up module. The lens holder is hollow, and has at least one lenses received therein. The lens mount is hollow, and an inner diameter of the lens holder being slightly greater than or equal to an outer diameter of the lens mount such that the lens holder capable of locating around the lens mount and movable along an axis of the lens mount. The image pick-up module is arranged to receive the light signal from the lenses.

Other advantages and novel features will become more apparent from the following detailed description when taken in conjunction with the accompanying drawings.

### BRIEF DESCRIPTION OF THE DRAWINGS

Many aspects of the digital camera module can be better understood with reference to the following drawings. The components in the drawings are not necessarily drawn to scale, the emphasis instead being placed upon clearly illustrating the principles of the present digital camera module. Moreover, in the drawings, like reference numerals designate corresponding parts throughout the several views.

FIG. 1 is an schematic view of a digital camera module, in accordance with a first preferred embodiment.

FIG. 2 is an schematic view of a digital camera module, in accordance with a second preferred embodiment.

FIG. 3 is an schematic view of a typical digital camera module.

### DETAILED DESCRIPTION OF PREFERRED EMBODIMENTS

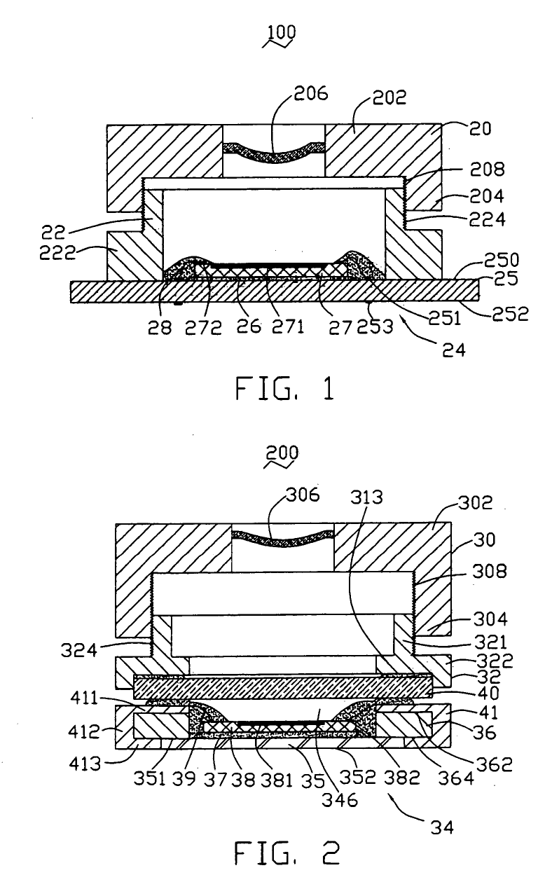

Referring now to the drawings, FIG. 1 shows a digital camera module 100 according to a first preferred embodiment. The digital camera module 100 is adapted for use in a portable electronic device (not shown), such as a mobile phone or a personal digital assistant (PDA), but the given the compact nature thereof it could prove useful in compact digital camera units or digital camcorders. The digital camera module 100 includes a lens holder 20, a lens mount 22, and an image pick-up module 24. The image pick-up module 24 includes a base plate 25, an adhesive means 26, an image pick-up chip 27, and a plurality of bonding wires 28.

The lens holder 20 is a hollow cylinder in shape with two open ends so that light can be transmitted therethrough. The lens holder 20 includes a first cylinder portion 202, and a second cylinder portion 204 integrally formed with the first cylinder portion 202. An inner diameter of the first cylinder portion 202 is smaller than that of the second cylinder portion 204. The first cylinder portion 202 has a plurality of lenses 206 (only one shown) received therein. The second portion 204 has an internal thread 208 defined in an inner periphery thereof.

The lens mount 22 is a hollow cylinder with two open ends so that light can be transmitted therethrough. The lens mount 22 has a projecting stage 222 projecting from an outer periphery thereof adjacent to a bottom thereof The lens mount 22 has an external thread 224 defined in an outer periphery thereof, corresponding to the internal thread 208 of the lens holder 20.

The base plate 25 is made of a material such as a plastic, a ceramic or a fibrous composite. The base plate 25 has a top surface 250, a bottom surface 252 on an opposite side of the base plate 25 to the top surface 251, a plurality of top pads 251 and a plurality of bottom pads 253. The top pads 251 are arranged in a circular pattern on the top surface 250 of the base plate 25. The bottom pads 253 are arranged in a circular pattern on the bottom surface 252. The base plate 25 is used for electrically connecting the image pick-up chip 27 to other printed circuit boards.

The image pick-up chip 27 attached to the top surface 250 of the base plate 25 via the adhesive means 26, surrounded by the top pads 251. A top side of the image pick-up chip 27 is arranged with a photosensitive area 271 and a plurality of chip pads 272 around the photosensitive area 271.

The bonding wires 28 are made of a conductive material such as gold or aluminum alloy. One end of each bonding wire 28 is connected/joined with a respective chip pad 272 of the image pick-up chip 27, and the other end of the bonding wires 28 is connected/joined with a respective top pad 251 of the base plate 25.

The adhesive means 26, such as a silicone, epoxy, acrylic, or polyamide adhesive, is also applied peripherally around the image pick-up chip 27, over the bonding wires 28. The adhesive means 26 covers the bonding wires 28 and junctions of the bonding wires 28 and the pads 272, 251, in order to protect the bonding wires 28 from cracking from metal fatigue and to ensure the firm connection between the ends of the bonding wires 28 and pads 272, 251. It is to be understood that the adhesive means 26 could be applied to the peripheral edge of the image pick-up chip 272 and/or over the bonding wires 28, therefore the adhesive means 26 covers part of each bonding wire 28 and junctions between the bonding wire 283 and the chip pads 272.

In assembling the digital camera module 100, the lens holder 20 is placed around the lens mount 22, with the internal thread 208 engaging with the external thread 224 of the lens mount 22. Then, the lens mount 22 is fixed on the image pick-up module 24, with the image pick-up chip 27 received in the lens mount 22 and the lens mount 22 secured on the base plate 25. During auto-focusing, a distance between the lens holder 20 and the image pick-up chip 27 is slightly adjusted to focus the digital camera module 100 by adjusting the thread engagement of the internal thread 208 of the lens holder 20 and the external thread 224 of the lens mount 224.

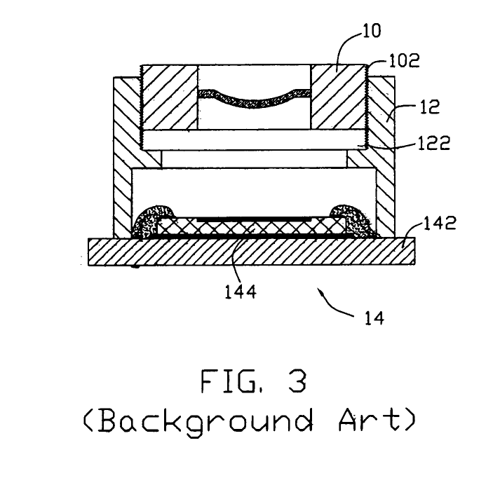

Referring to FIG. 3, another digital camera module 200 according to a second preferred embodiment is provided. The digital camera module 200 includes a lens holder 30, a lens mount 32, and an image pick-up module 34. The image pick-up module 34 includes a base plate 35, a flange 36, an adhesive means 37, an image pick-up chip 38, a plurality of bonding wire 39, a transparent plate 40, and a plurality of metal plates 41.

The lens holder 30 is a hollow cylinder in shape with two open ends so that light can be transmitted therethrough. The lens holder 20 includes a first cylinder portion 302, and a second cylinder portion 304. An inner diameter of the first cylinder portion 302 is smaller than that of the second cylinder portion 304. The cylinder portion 302 has a plurality of tenses 306 (only one shown) received therein. The second portion 304 has an internal thread 308 defined in an inner periphery thereof.

The lens mount 32 is a hollow cylinder with two open ends so that light can be transmitted therethrough. The lens mount 32 includes an upper cylinder portion 321, and a lower cylinder portion 322 extending from an outer periphery of the upper cylinder portion 321. An inner diameter of the lower cylinder portion 321 is larger than that of the upper cylinder portion 321. The upper cylinder portion 321 has an external thread 324 defined in an outer periphery thereof, corresponding to the internal thread 308 of the lens holder 30.

The base plate 35 is made of a material such as a plastic, a ceramic or a fibrous composite. The base plate 35 has a top surface 351, and a bottom surface 352.

The flange 36 is a hollow rectangle in shape, and includes an upper surface 362 and a lower surface 364. The lower surface 364 is adhered to the top surface 351 of the base plate 35, defining a receiving space 346 with the base plate 35.

The image pick-up chip 38 is adhered to the top surface 351 of the base plate 35 via the adhesive means 37. A top side of the image pick-up chip 38 is arranged with a photosensitive area 381 and a plurality of chip pads 382 around the photosensitive area 381.

The bonding wires 39 is same as the bonding wires 28. One end of each bonding wires 38 is connected/joined with a respective chip pad 382 of the image pick-up chip 38, and the other end of the bonding wires 39 is connected/joined with the metal plate 41.

The metal plate 41 has a first plate portion 411, a second plate portion 413 parallel to the first plate portion 411, and a third plate portion 412 connecting with the first plate and the second plate portion 413. The first plate portion 411 is placed on the upper surface 362 of the flange 36. The second plate portion 413 is adhered to the lower surface 364 of the flange 36. The third plate portion 412 is jointed to a side of the flange 36. The first plate portion 411 electrically connects with the bonding wires 39, and the second plate portion 412 electrically connects with a printed circuit board.

The transparent plate 40 may be a transparent glass, and is fixed on the metal plate 41, thus sealing the photosensitive area 381 of the image pick-up chip 38.

In assembling the digital camera module 200, the lens holder 30 places around the lens mount 32, with the internal thread 308 engaging with the external thread 324 of the lens mount 32. Then, the lens mount 32 is fixed on the image pick-up module 34, with the transparent plate 40 securely received in a bottom of the lens mount 32. During auto-focusing, a distance between the lens holder 30 and the image pick-up chip 38 is adjusted to focus the digital camera module by adjusting the thread engagement of the internal thread 308 of the lens holder 30 and the external thread 2324 of the lens mount 32.

In the embodiments, since the thread engagement between the lens holder and the lens mount is disposed on outer periphery of the lens mount, dust and/or particle pollution/contamination associated with friction between the lens holder and the lens mount can be effectively prevented from entering the pick-up module. In the second embodiment, a transparent plate 40 is disposed on the image pick-up chip 38 to completely prevent particles or dust from falling onto the image pick-up chip 38, thus improving image quality of the digital camera module.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A digital camera module, comprising:
a lens holder having a first hollow portion and a second hollow portion, the first hollow portion having at least lens received therein, the lens holder having an internal thread defined in an inner periphery of the second hollow portion,
a lens mount having an external thread defined in an outer periphery thereof, the external thread engaging with the internal thread of the lens holder; and
an image pick-up module being arranged to receive light from the lenses.

2. The digital camera module as claimed in claim 1, wherein the lens holder is a cylinder in shape, a diameter of the second hollow portion is greater than that of the first hollow portion.

3. The digital camera module as claimed in claim 1, wherein the lens mount includes an upper cylinder portion and a lower cylinder portion, and the external thread is formed on an outer periphery of the upper cylinder portion.

4. The digital camera module as claimed in claim 3, further comprising a transparent plate secured on the lower cylinder portion of the lens mount.

5. The digital camera module as claimed in claim 1, wherein the image pick-up module comprises a base plate, and an image pick-up chip secured on the base plate.

6. The digital camera module as claimed in claim 1, wherein the image pick-up chip has a plurality of chip pads arranged on a top side thereof

7. The digital camera module as claimed in claim 6, wherein the base plate has a plurality of top pads arranged on a top surface, and a plurality of bottom pads arranged on a bottom surface on an opposite side of the base plate to the top surface, the chip pads of the image pick-up chip electrically connect with corresponding top pads of the base plate via a plurality of bonding wires.

8. The digital camera module as claimed in claim 6, wherein the image pick-up module includes a flange arranged on the upper surface of the base plate.

9. The digital camera module as claimed in claim 8, wherein the image pick-up module further includes a metal plate having a first plate portion disposed on a first surface of the flange, a second plate portion disposed beneath the lower surface of the base plate, and a third plate portion connecting with the first plate portion and the second plate portion, the chip pads of the image pick-up chip electrically connecting with the metal plate via a plurality of bonding wires.

10. A digital camera module, comprising:
a lens holder defining a central hollow, and having at least one lens received therein,
a lens mount defining a central hollow, an inner diameter of the lens holder being slightly greater than or equal to an outer diameter of the lens mount such that the lens holder is capable of movably surrounding the lens mount along an axis of the lens mount, and
an image pick-up module being arranged to receive the light from the lens.

11. The digital camera module of claim 10, wherein the lens holder has an internal thread defined in an inner periphery thereof, the lens mount has an external thread defined in an outer periphery thereof, the external thread engaging with the internal thread of the lens holder.

12. The digital camera module of claim 11, wherein the lens holder is a cylinder in shape, and defines a first hollow portion and a second hollow portion, a diameter of the second hollow portion is greater than that of the first hollow portion, the at least one lens is received in the first hollow portion, the internal thread is defined in the second hollow portion.

13. The digital camera module as claimed in claim 11, wherein the lens mount includes an upper cylinder portion and a lower cylinder portion, and the external thread is formed on outer periphery of the upper cylinder portion.

14. The digital camera module as claimed in claim 13, further comprising a transparent plate secured to the lower cylinder portion of the lens mount.
